(19) United States
(12) Patent Application Publication
(10) Pub. No.: US 2018/0317702 A1
(43) Pub. Date: Nov. 8, 2018

(54) METAL FILM AND METHOD FOR HEATING THE SAME

(71) Applicant: E-WENCO S.R.L., Legnano (MI) (IT)

(72) Inventors: Ennio CORRADO, Arsago Seprio (VA) (IT); Chiara CREMONESI, Legnano (MI) (IT)

(21) Appl. No.: 15/770,760

(22) PCT Filed: Oct. 25, 2016
(86) PCT No.: PCT/IB2016/056409

§ 371 Date: Apr. 25, 2018

(30) Foreign Application Priority Data
Oct. 27, 2015 (IT) 102015000066016(U

(51) Int. Cl. A47J 36/04; A47J 27/022; B22D 11/00; C22C 21/02

(52) U.S. Cl. CPC A47J 36/04; C22C 21/02; B22D 11/003; A47J 27/022

(57) ABSTRACT

A metal film or plate, a method for obtaining thereof and some practical applications are described. The film is subject to heating by Joule effect created by parasitic currents induced by a time-varying magnetic field. The film is constituted by a metal alloy containing a first metal in a percentage comprised between 90% and 99% by mass of the total mass and a second metal in a percentage comprised between 1% and 10%. The thickness of the film is equal to, or lower than, 10 cm. The first metal is an amagnetic metal and the second metal is a ferromagnetic metal. In this way the film has ferromagnetic behavior still being mainly made by amagnetic metal. This allows exploiting in an optimal way both the mechanical features of amagnetic metals, and the magnetic features of ferromagnetic metals.

### FIELD OF THE INVENTION

The present invention relates to a metal film which applies in a number of technical fields, for example for making containers in the food field or for making components of vehicles and car bodies in the automotive field, and a method to heat the film in a magnetic field.

### BACKGROUND ART

It is known that by subjecting a metallic element to a magnetic field variable in space and/or time, electrical currents are induced in the element itself; these electrical currents are defined parasitic currents (or eddy currents) and, in their turn, they heat the metallic element by Joule effect which cooperates with the dissipative effect re-orienting the magnetic domains, known in literature as hysteresis loop which is typical and characteristic of ferromagnetic materials.

A number of practical applications exploit this phenomenon. For example, the heating of pots on induction hobs and the production of electromagnetic brakes in some types of heavy vehicles, have to be enumerated among the most known.

Not all of the metals are suitable to make items of practical interest exploiting this phenomenon.

For example, for making pots for induction hobs it is necessary to use a metal having sufficiently low electrical resistance for efficiently conducting the induced parasitic currents, but beyond a certain lower limit of electrical resistance, sufficient dissipation of energy to heat the pot by Joule effect is not obtained.

The same drawback can be found in other technological fields.

Therefore, over time some metals have been preferred to others, so much that de facto standards have been created in reference markets.

Referring once again to the example of the pots for induction hobs, cast iron and some steels have been preferred to aluminum, although the latter has lower specific weight—an aspect that would allow making light and cheaper pots—and high thermal conductivity making it more suitable for cooking food. Actually, pots made of aluminum suitable for induction hobs exist, but they are solutions as that described in WO 2011/064455, wherein an insert is mechanically coupled with the body of the pot made of aluminum to perform the function of induction-heated element; the insert is generally made of magnetic steel suitable for this application. The induction hob heats the insert, which in its turn transfers heat to the body of the pot made of aluminum.

EP 2220975 describes another example of food container suitable to be heated on induction hobs. The bottom of the container is made of an alloy constituted by ferromagnetic material and aluminum. The minimum quantity of ferromagnetic material must be equal to its percolation index of powders.

Also in railway, automotive and industrial automation field, iron and some steels are some of the preferred metals to make electromagnetic brakes.

In other words, other metals less performing from a mechanical or thermal point of view, but better responding to the magnetic fields in the context of the phenomenon described above, have been preferred to some metals having mechanical and/or thermal properties more suitable for a particular use.

In general, metals showing high values of thermal conductivity also boast high electrical conductivity, but sometimes excessive to obtain efficient heat dissipation caused by the induction. For example silver, gold and aluminum are characterized by optimal thermal and electrical conductivity, but are poorly reactive to variable magnetic fields.

Notoriously, metals can be classified depending on the attitude to magnetize in the presence of a magnetic field. Quantitatively and practically, metals are classified as ferromagnetic, diamagnetic and paramagnetic depending on the value of the relative magnetic permeability, in its turn corresponding to the ratio:

μᵣ=μ/μ₀, (1)

between the absolute magnetic permeability of the metal and the magnetic permeability μ₀ of vacuum. The absolute magnetic permeability is defined as the ratio between the magnetic induction B and the intensity H of the magnetizing field, i.e.:

μ=B/H. (2)

The magnetic permeability of vacuum μ₀ is one of the fundamental physical constants; its value is expressed in Henry/meter in the International System:

μ₀=4π·10⁻⁷ H/m. (3)

The relative magnetic permeability is constant in diamagnetic metals (μ<μ₀) and slightly lower than the unit. In paramagnetic metals the relative magnetic permeability is slightly higher than the unit and is inversely proportional to temperature. In ferromagnetic metals the relative magnetic permeability is much higher than the unit (μ>>μ₀) and varies, in addition to the temperature, also upon variation of the magnetizing field.

There are a few metals presenting ferromagnetic and ferrimagnetic properties at room temperature, such as for example iron, cobalt and nickel. Some rare earth elements are ferromagnetic at temperatures even much lower than room temperature.

The following table 1 summarizes the classification.

TABLE 1

| Metal | Relative Magnetic Permeability |
|---|---|
| Ferromagnetic | μᵣ >>1 |
| Diamagnetic | μᵣ <1 |
| Paramagnetic | μᵣ >1 |

The difference between the values of the relative magnetic permeability of paramagnetic metals, with respect to diamagnetic metals, is minimal and often negligible for practical purposes, particularly for what concerns the induction heating.

Independently from the just summarized classification, for simplicity in the following description paramagnetic metals and diamagnetic metals will be simply defined amagnetic or non-magnetic metals, the same way as metals that in general are not appreciably interacting with magnetic fields, among which aluminium, copper, titanium, tungsten can be mentioned, for example.

As mentioned above, some amagnetic metals have optimal mechanical and thermal conductivity properties, but are not directly usable in applications providing for heating by parasitic currents, precisely because other metals such as iron, cast iron or some steels having more effective response to magnetic fields are preferred to these ones. The use of amagnetic metals is only possible in combination with ferromagnetic metals, for example by assembling parts made of different metals, as described above in the example of the pots made of aluminum.

For example, aluminum (as a foil) has thermal conductivity equal to 190 kcal/m° C.—i.e. at least seven times higher than a common stainless steel, and copper (electrolytic) has thermal conductivity equal to 335 kcal/m° C.—i.e. at least twelve times higher than stainless steel. Therefore, in an application providing for the induction heating and for which it is important having the maximal thermal conductivity, copper will be preferable to aluminum and the latter to steel.

Thus, it is desirable to be able to overcome the limits described above, also to exploit amagnetic metals in all practical applications providing for heating caused by parasitic currents induced by magnetic fields.

WO 2005/060802 describes a ceramic pan, in particular for preparing the fondue. The bottom of the pan is coated by a layer that can be induction heated and is applied by hot spraying technique. It is a metallic material, preferably ferromagnetic material, showing good thermal and electrical conductivity.

FR 2846340 describes a method for making bands made of aluminum for the manufacturing of kitchenware. The bands are continuously cast with a thickness comprised between 4 mm and 12 mm and then subjected to cold calendering until obtaining thickness reduction comprised between 10% and 60%. Then the bands are subjected to annealing at a temperature comprised between 320° C. and 100° C. The bands show elasticity limit higher than 40 MPa, breaking strength higher than 120 MPa, elongation higher than 23% and surface dimension of pellets lower than 100 mum. In an example described, the band consists of iron 1.1% by mass, silica 1.2% by mass, small quantities of manganese, copper, magnesium and the remainder is aluminum.

### SUMMARY OF THE INVENTION

Therefore, it is an object of the present invention to provide a method for making manufactured products made at least in part of an amagnetic metal, for example paramagnetic or diamagnetic or antiferromagnetic metal, but anyway subject to efficient heating caused by parasitic currents induced in the metal by magnetic fields.

It is still another object of the present invention to provide manufactured products of the type just described.

Another object of the present invention is to make the amagnetic metals compatible with applications providing for the induction heating.

Another object of the present invention is to provide manufactured products that can be more efficiently induction heated and by consuming less power with respect to known solutions.

Therefore the present invention, in a first aspect thereof, concerns a method according to claim 1, to make a metal film or a metal plate subject to heating by Joule effect created by parasitic currents induced by a time-varying magnetic field cooperating with the dissipative re-orienting effect of magnetic domains, known in literature as hysteresis loop which is typical and characteristic of ferromagnetic materials.

In particular, the method comprises the steps of:

a) preparing a metal alloy containing a first metal or a first mixture of metals in a percentage comprised in the range 90%-99% by mass of the total mass of the alloy (wt. %), and containing a second metal or a second mixture of metals in a percentage comprised in the range 1%-10% by mass of the total mass of the alloy (wt. %);

b) making a film or a plate constituted by said alloy, with a thickness equal to or lower than 10 cm, preferably lower than 500 microns.

From now on, for the sake of simplicity, the word “film” will also be used to identify the plate.

For the purposes of the present invention, the term “alloy” is used to identify those materials in which the mixing of metals or other constituents is intentional; the term “alloy” thus is irrespective of undesired impurities being present or not in starting compounds, impurities that can derive from the nature of minerals from which the compounds are extracted, and from the mining and metallurgical processes used.

Unlike what you may encounter in solutions according to the known art, in the method proposed herein the first metal is an amagnetic metal, i.e. a metal not interacting with magnetic fields as a diamagnetic or paramagnetic metal, and the first mixture of metals is amagnetic and/or can exclusively comprise non-magnetic metals; the second metal is a ferromagnetic or ferrimagnetic metal, i.e. a metal not sensibly interacting with magnetic fields, and the second mixture of metals exclusively comprises ferromagnetic or ferrimagnetic metals.

The main advantage is that the film has ferromagnetic behavior still being constituted by an alloy made at least by 90% with non-magnetic metals or an amagnetic mixture of metals. This allows obtaining a film subject to induction heating with significant efficiency levels of thermal transduction (higher than 70%) still using non-magnetic, diamagnetic and paramagnetic metals or amagnetic mixtures of metals.

In other words, the method according to the present invention considerably widens the chances offered to the designer, who can choose to exploit both the mechanical features and the features of non-magnetic mixtures of non-magnetic metals, and the magnetic features of ferromagnetic metals.

The film obtained by the just described method, which is also an object of the present invention, is usable in various technical fields.

For example, it can be used as coating or internal core of pots and similar containers, to make them adapted for cooking by induction hobs. By considering the case of the internal core, the film can be made of multilayer structure by applying two additional layers respectively at the top surface and the bottom surface of the film, in order to obtain an insert wherein the film is mechanically shielded.

Further, if the film is made of materials having relatively low melting temperatures (such as for example aluminum), and if the additional layers are made of insulating materials, the film would also be thermally shielded by the additional layers.

Still in the food context, the film allows making containers, for example trays for food suitable for being directly heated on the induction hob. The trays for food made of aluminum are amongst the most widespread ones, but usually they cannot be used in microwave ovens, but only in conventional ovens. By making sure to select metals suitable for food use, the film according to the present invention allows making containers that can be induction heated, with evident convenience, speed and energy saving benefits.

The energy saving is such that, in the future, the present invention could enable cooking and heating food only by exploiting the solar power intercepted by photovoltaic panels or alternative power sources.

Another application consists in thermoforming items. The film can be used for coating an item and can be induction heated up to reaching the softening or melting point of the alloy so that it adheres to the surface of the coated item, almost wetting it. In this way, it is possible to coat vehicle components and parts, but also items that would otherwise be chromed.

The film can also be used as sandwiched, and under vacuum conditions, between two layers of electrically insulating material. The induction-obtained heating can lead the film to complete melting, and to become liquid. This allows exploiting the latent heat of fusion, if necessary.

Another possible application is in the building field. The film can serve to make radiating surfaces, for heating air or fluids.

In general, the film can be coupled to, or integrated in, manufactured products per se unsuitable for being induction heated, so that they can be heating too.

The Applicant found that films obtained with the alloy described above, behave as if they were completely made of ferromagnetic or ferrimagnetic metal and can be heated if subjected to electromagnetic field.

Preferably, the content of the first metal or the first mixture of metals in the alloy is complementary with respect to the content of the second metal or the first mixture of metals with proportions equal to, for example, 99/1, 98/2, 97/3, 96/4, 95/5, 94/6, 93/7, 92/8, 91/9, 90/10, or 98.5/1.5, 97.5/2.5, 96.5/3.5, etc. In this circumstance other metals, in addition to the first and second metals mentioned above, are not bonded.

Alternatively, in an embodiment the alloy also comprises less than 1% by mass of one or more rare-earth elements, wherein the rare-earth elements are identified in accordance with IUPAC definition (International Union of Pure and Applied Chemistry), or an oxide thereof.

Preferably, metals are respectively classified as amagnetic or ferromagnetic metals depending on the magnetic permeability at room temperature and the film already has ferromagnetic behavior at room temperature.

In an embodiment, the alloy also comprises non-metals, such as carbon, and/or metalloids, such as silicon, in small quantities, preferably lower than or equal to 1% (wt.), in addition to metals. Some non-metals and some metalloids have amagnetic or ferromagnetic behavior. Therefore, the non-metals and/or metalloids content in the alloy will take into account this aspect. The choice of the nature and quantity of non-metals and/or semi metals depends upon the result you want to achieve. For example, the alloy can contain less than 1% by mass (of the total mass) of carbon to increase the melting point of the alloy itself.

Preferably, the alloy is obtained by melting or sintering. Preferably, the film is obtained by the rolling technique.

In the preferred embodiment, the mass content of the first metal or first mixture of metals, with respect to the total mass of the alloy, is comprised in the range 95%-99%, and the mass content of the second metal or second mixture of metals, with respect to the total mass of the alloy, is comprised in the range 1%-5%.

Preferably, the film is embossed to maximize the surface exposed to the magnetic field that must cause the induction heating. Depending on the applications, the embossing can also serve to maximize the heat exchange surface.

Only by way of example, these examples are mentioned. The first metal is selected from silver, copper, aluminum, platinum and the first mixture is a mixture of two or more first metals. The second metal is selected from nickel, iron, cobalt, and the second mixture is from two or more second metals.

In an embodiment, the titanium content in the alloy, if present, is lower than 0.5% by mass of the total mass, and is preferably comprised in the range 0.1%-0.2%.

In an embodiment, the boron content in the alloy, if present, is lower than 0.5% by mass of the total mass, and is preferably comprised in the range 0.1%-0.2%.

In an embodiment, the iron content in the alloy, if present, is lower than 3% by mass of the total mass, and is preferably comprised in the range 1%-1.5%.

The film is directly usable as described above, or can be coupled with other metal or plastic materials, in order to define a multilayer structure. This solution allows combining other materials with the film according to the present invention, which have the desired mechanical, thermal or electrical features, for example to stiffen the film, maximize the heat exchange or electrically insulate the film itself.

For example, if the film is used to construct a heat exchanger for liquids, it can be advantageous to insulate the film from the electrical point of view by coupling it to a material suitable to the purpose, for example a resin electrically, but not thermally, insulating.

A second aspect of the present invention concerns a film according to claim 11.

Features and advantages of the film are the same described above relating to the method for obtaining thereof.

Claims 12-17 describe preferred features of the film.

### BRIEF LIST OF THE FIGURES

Further characteristics and advantages of the invention will be more evident by the review of the following specification of a preferred, but not exclusive, embodiment, which is depicted for illustration purposes only and without limitation, with the aid of the attached drawings, in which:

FIG. 1 is a schematic diagram relating to the method according to the present invention;

FIG. 2 is a schematic view of a first film subjected to a test, according to the present invention;

FIG. 3 is a schematic view of a second film subjected to a test according to the present invention;

FIG. 4 is a perspective view of the first film according to the present invention;

FIG. 5 is a perspective view of a pot coated with the first film according to the present invention;

FIG. 6 is a sectional view of the pot showed in FIG. 5;

FIG. 7 shows a car dashboard partially coated with a film according to the present invention;

FIG. 8 is a schematic view of a film according to the present invention, integrated in a multilayer structure.

### DETAILED DESCRIPTION OF THE INVENTION

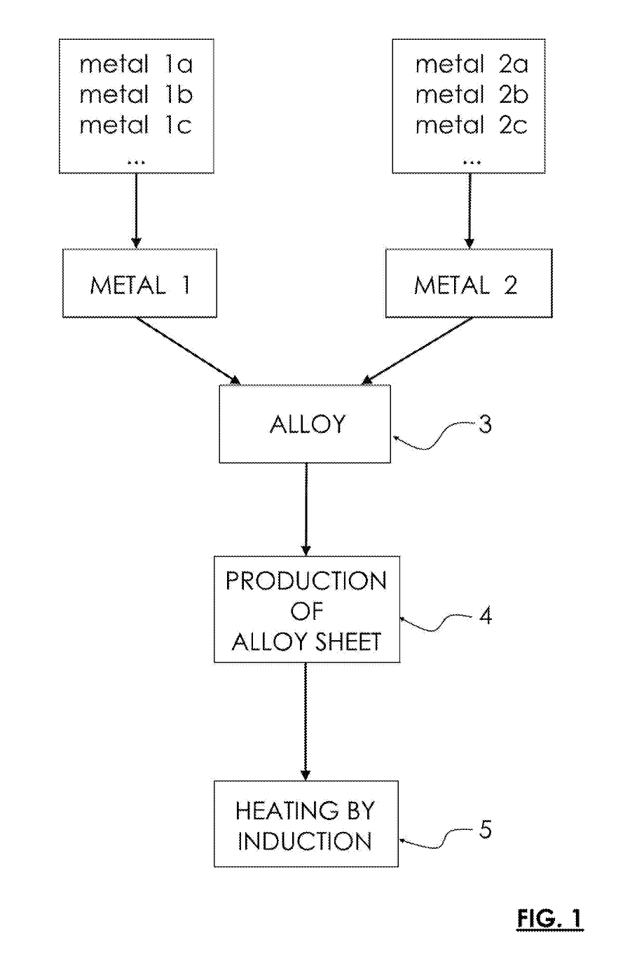

FIG. 1 is a simplified diagram of the method according to the present invention. A first metal 1, having non-magnetic behavior—meaning that at room temperature it doesn't noticeably interact with magnetic fields—and a second ferromagnetic metal 2—i.e. interacting at room temperature with magnetic fields—are used to implement a metal alloy 3. The proportions of the two metals are those described above and in the claims.

The alloy can be obtained with different techniques, for example melting, sintering, dispersing a powdered metal in a liquid metallic phase.

Referring for the sake of simplicity to the melting, the alloy is solidified in billets, which are then used in a rolling mill for obtaining the film of the desired thickness, anyway lower than 10 cm.

The rolling technique is well known and the detailed description is not needed. For example, the following movie available on the YouTube internet platform explains how films made of food aluminum are produced in a rolling mill: https://www.youtube.com/watch?v=f4OTj9yNOak.

For example, the production 4 can occur precisely by the rolling, which is the preferred technique.

The so-produced film is thus ready for step 5 of induction heating 5.

The alloy can also be obtained starting from several first metals 1a, 1b, 1c, . . . 1n, and several second metals 2a, 2b, 2c, . . . 2n, as described above.

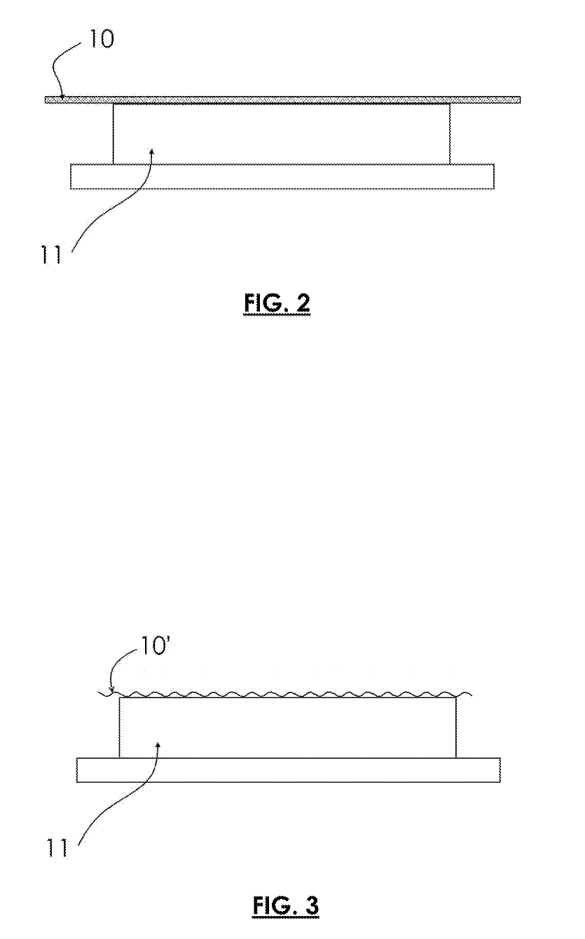

FIG. 2 is an example of effectiveness test. A film sheet 10 is located on an induction hob 11, whose power is adjustable between 10 W and 3000 W. When the induction hob 11 is operating, in few seconds the film 10 rapidly heats, because of the dissipation of energy by Joule effect cooperating with the dissipative re-orienting effect of the magnetic domains known in literature as hysteresis loop, which is typical and characteristic of ferromagnetic materials.

The following examples describe the phenomenon.

### EXAMPLES

### Example 1

Alloy constituted by silver, copper, nickel and rare-earth elements in the mass percentages depicted in the table below.

| Diamagnetic metals | Silver | Copper |
|---|---|---|
| | 47% | 49.5% |

| | |
|---|---|
| Ferromagnetic Metal | Nickel |
| | 3% |
| Other Metals | Rare Earth Silicide 0.5% |
| | or else MishMetal 0.5% |
| Thickness of the film | 200 μm |

In its turn, the rare-earth silicide is composed by Si=40%-45%, rare-earth elements 8%-10% and iron for the remainder; MishMetal is typically composed by cerium 50%, lanthanum 25% and a little percentage of neodymium and praseodymium.

The film has been heated with the induction hob 11 set to the power of 1000 W and reached the temperature of about 800° C. (red color).

### Example 2

Alloy constituted by copper, nickel and rare-earth elements in the mass percentages depicted in the table below.

| | |
|---|---|
| Diamagnetic metals | Copper |
| | 89.5% |
| Ferromagnetic Metal | Nickel |
| | 10% |
| Other Metals | Rare Earth Silicide 0.5% |
| | or else MishMetal 0.5% |
| Thickness of the film | 100 μm |

In its turn, the rare-earth silicide is composed by Si=40%-45%, rare-earth elements 8%-10% and iron for the remainder; MishMetal is typically composed by.

The film has been heated with the induction hob 11 set to the power of 1000 W and reached the temperature of about 1100° C. (bright red color).

### Example 3

Alloy constituted by aluminum and iron in the mass percentages depicted in the table below.

| | |
|---|---|
| Diamagnetic metals | aluminium |
| | 97.3% |
| Ferromagnetic Metal | Iron |
| | 2.7% |
| Thickness of the film | 100 μm |

The film has been heated with the induction hob 11 set to the power of 250 W and reached the temperature of about 250° C.

### Example 4

Alloy constituted by aluminum and iron in the mass percentages depicted in the table below.

| | |
|---|---|
| Diamagnetic metals | aluminium |
| | 97% |
| Ferromagnetic Metal | Iron |
| | 3% |
| Thickness of the film | 1.2 cm |

The film has been heated with the induction hob 11 set to the power of 400 W and reached the temperature of about 50° C.

### Example 5

Alloy constituted by aluminum and iron in the mass percentages depicted in the table below.

| | |
|---|---|
| Diamagnetic metals | aluminium |
| | 97.3% |
| Ferromagnetic Metal | Iron |
| | 2.7% |
| Thickness of the film | 1.1 mm |

The film has been heated with the induction hob 11 set to the power of 250 W and reached the temperature of about 200° C.

FIG. 3 shows a film 10′ identical to the film 10 of the example 3, but embossed to increase the exchange surface with the magnetic field generated by the hob 11.

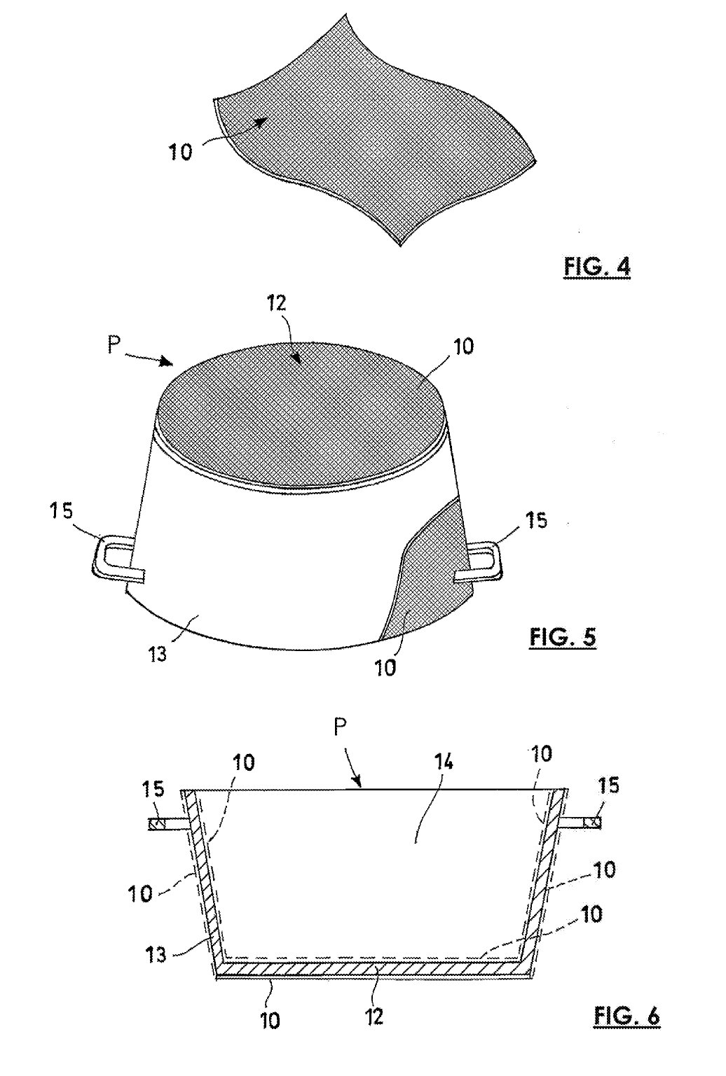

In FIG. 4 a portion of a first film 10 made of aluminum and iron alloy according to the invention, is schematically depicted. For graphical reasons, in the figures the thickness of the film 10 was deliberately denoted, by way of illustration, much bigger than the actual size and not proportioned to the other dimensions of the pot: as mentioned, in fact, the thickness of the film 10 is in the order of microns and a real representation thereof wouldn't have been noticeable in the drawings.

The film 10 is made of aluminum and iron alloy, with aluminum being present in quantity comprised between 97% and 99% by mass (wt. %) and iron being present in quantity comprised between 1% and 3% (wt. %), advantageously between 1% and 1.5% (wt. %). The alloy can further comprise titanium and/or boron, each in quantity not higher than 0.5%, advantageously comprised between 0.1% and 0.2%. These metals have the purpose to carry out a satisfactory refining of the alloy, thus allowing the formation of smaller and substantially spherical-shaped granules and improving its overall mechanical characteristics. Furthermore, other elements (metallic and non-metallic) can be present in traces, generally in an overall quantity lower than 0.1%.

The film 10 has thickness comprised between 5 μm and 200 μm and is preferably obtained by rolling.

In FIG. 5 a pot P is depicted and equipped with a bottom 12 and a lateral wall 13 which define an inner compartment 14 adapted to contain liquid or solid substances intended to be heated. Advantageously, at the lateral wall 13 there can be handles 15 for the user's grip. The handles 15 can be made of thermally non-conductive material or with appropriate thermal insulation from the body of the pot, for example made of Bakelite.

The bottom of the pot P is flat to provide optimum support on the induction hob and can be made by any material suitable for heating and/or cooking foodstuffs, foods or beverages, for example ceramic, glass, borosilicate glass, fiberglass, porcelain, plastic material, etc., as well as plastics able to withstand temperatures in the order of 180-200° C. without damages and without releasing toxic substances that would otherwise contaminate the dishes.

At least the bottom 12 of the pot P is coated by the film 10 of aluminum and iron alloy having the features described above. When the magnetic field of an induction hob is activated, induced currents within the film 10 heat it and, in turn, it transfers the heat to the material constituting the bottom 12 and the walls 13 of the pot.

In FIG. 6 how the film 10 can be provided also as a coating of the lateral wall 13 of the pot P is schematically depicted (partially represented), for aesthetic reasons or if it is desired to locate the inductor at the pot sides.

The film 10 can advantageously be applied to the bottom 12 and the walls 13 of the pot P by means of glues or resins able to withstand operating temperatures between 180 and 200° C.

As showed in FIG. 6 (with dashed line representation), the film 10 of aluminum and iron alloy according to the invention can only be provided at the external surface of the bottom 12 (and, in case, of the lateral wall 13) or also (or only) at the internal surfaces.

Anyway, the solution with external coating is the optimal solution both because it avoids a possible damage of the film itself that could occur (if present inside) in case the content of the pot needs to be blended or handled with spoons, forks, etc., and because it allows to keep the inside of the pot, directly in contact with the food to be heated or cooked, made of the material (glass, borosilicate glass, fiberglass, porcelain, ceramic, polymeric materials etc.) most suitable for that specific use.

A film of non-magnetic metals and ferromagnetic metals alloy according to the invention, applied to a pot P made of ceramic, glass, borosilicate glass, etc., guarantees ferromagnetic and electrical conductivity features to the pot P itself, that make it suitable for the operation with the induction hob, still maintaining all of the peculiar features of the materials constituting the body of the pot P.

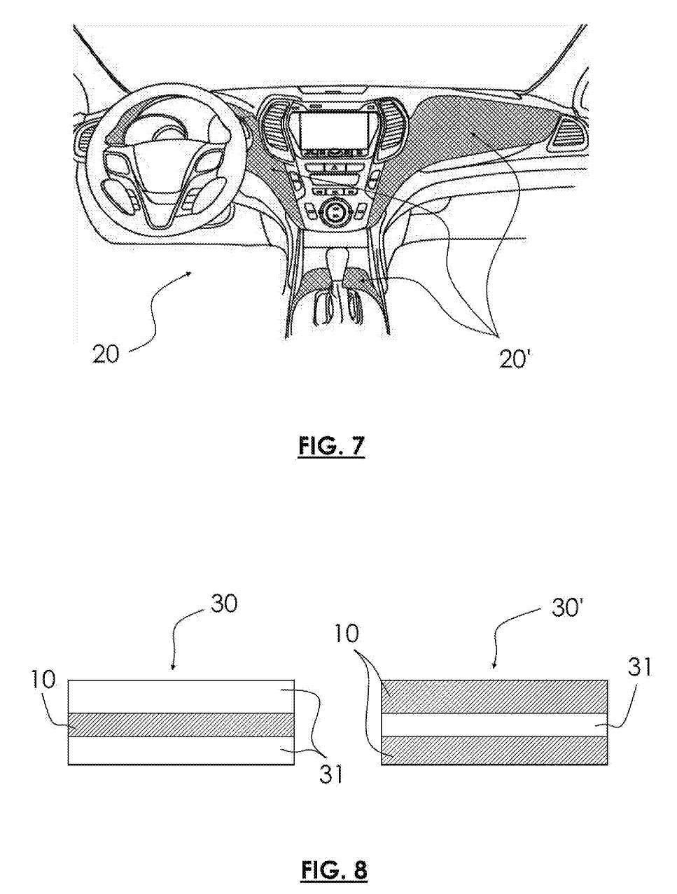

FIG. 7 shows another example of application of the present invention. A film 10 is used to coat parts 20′ of a car dashboard 20, for aesthetic purposes. One of the advantages offered by the present invention is the chance to obtain elements 20′ that are thermoformed instead of die cast, molded or deep drawn. In the example showed in FIG. 7, coating elements are obtained starting from the film 10 having the composition of the example 3. The film 10 is located on a shape and subjected to induction heating up until the softening point is reached. At this point, the film 10 is laid down on the shape to copy its surfaces, i.e. to copy its tridimensional development. Thus, a step of cooling, separation from the shape and edging follows. The so obtained element 20′ is polished and glued to the dashboard 20.

With the same method it is possible to make components in which the shape remains embedded in the coating obtained by softening or melting the film 10. In fact, the film can be heated up to the melting point to liquefy it, if necessary.

FIG. 8 shows two possible multilayer structures 30, 30′ that can be obtained with a film 10 or 10′ according to the present invention. In order to obtain a mechanically resistant structure 30, 30′ or to lend particular thermal or electrical features thereto, it is possible to couple at least one additional layer 31 with the film 10. On the left in FIG. 8, the film 10 is sandwiched between two layers (of different thickness) 31, for example an electrically insulating material, such as glass, borosilicate glass, fiberglass, porcelain, ceramic, polymeric materials, etc. Thereby, it is possible to maximize the heat exchange of the film 10 by protecting it, i.e. avoiding its approach to the melting point. On the right in FIG. 8, two films 10 are sandwiching one layer of material 31.

If it is desired to lend flexural strength, for example, the film 10 can also be coupled with other layers, for example a steel or titanium foil, taking care that the same is not shielding the film 10 with respect to the induced magnetic field.

1. A method for making a metal film or film with metallic behavior (10), or a metal plate or plate with metallic behavior, subject to heating by Joule effect, comprising the steps of:
a) preparing a metal alloy containing a first metal (1) or a first mixture of metals (1a, 1b, 1c, . . . In) in a percentage comprised in the range 90%-99% by mass of the total mass of the alloy, and containing a second metal or a second mixture of metals (2a, 2b, 2c, . . . 2n) in a percentage comprised in the range 1%-10% by mass of the total mass of the alloy;
b) making a film or plate (10) constituted by said alloy and having thickness equal to or lower than 10 cm, characterized in that the first metal is an amagnetic metal and the first mixture of metals is amagnetic and/or exclusively comprises non-magnetic metals, and in that the second metal is a ferromagnetic or ferrimagnetic metal and the second mixture of metals exclusively comprises ferromagnetic metals, so that the film has ferromagnetic behavior.

2. Method according to claim 1, wherein the metals (1, 2) are respectively classified as non-magnetic, for example diamagnetic or paramagnetic or antiferromagnetic metals, or else magnetic metals, for example ferromagnetic and ferrimagnetic ones, depending on the magnetic permeability at room temperature, and the film has ferromagnetic behavior at room temperature.

3. Method according to claim, wherein the thickness of the film (10) is comprised between 5μπι and 10 cm, preferably lower than 500 microns

4. Method according to claim 1, wherein the alloy is obtained by melting or sintering.

5. Method according to claim 1, wherein the alloy contains less than 1% by mass of:
one or more rare-earth elements, wherein the rare-earth elements are identified according to IUPAC definition, or an oxide thereof, or else:
MishMetal, in its turn composed of cerium 50%, lanthanum 25% and a little percentage of neodymium and praseodymium;
non-metals, such as carbon, and/or semimetals, such as silicon.

6. Method according to claim 1, wherein the mass content of the first metal (1) or the first mixture of metals (1a, 1b, 1c, . . . In), with respect to the total mass of the alloy, is comprised in the range 95%-99%, and the mass content of the second metal (2) or the second mixture of metals (2a, 2b, 2c, 2n), with respect to the total mass of the alloy, is comprised in the range 1%-5%.

7. Method according to claim 1, wherein the first metal (1) is selected from silver, copper, aluminum, platinum, boron and the first mixture is a mixture of two or more first metals (1a, 1b, 1c, . . . In) and the second metal (2) is selected from nickel, iron, cobalt, and the second mixture is from two or more second metals (2a, 2b, 2c, . . . 2n).

8. Method according to claim 7, wherein:
the titanium content in the alloy, if present, is lower than 0.5% by mass of the total mass, and is preferably comprised in the range 0.1%-0.2%;
the boron content in the alloy, if present, is lower than 0.5% by mass of the total mass, and is preferably comprised in the range 0.1%-0.2%;
the iron content in the alloy, if present, is lower than 3% by mass of the total mass, and is preferably comprised in the range 1%-3%.

9. Method according to claim 1, wherein the film (10) obtained by rolling, for example, is coupled with other metal or plastic materials, in order to define a multilayer structure, wherein the other materials are selected to lend the desired mechanical, thermal or electrical features to the film, for example to stiffen the film, maximize the heat exchange or electrically insulate the film itself.

10. Method according to claim 1, wherein the film is coupled with, or integrated in, manufactured products (P) per se unsuitable for being induction heated, so that they can be heating too.

11. A metal film (10) or plate subjected to an electromagnetic field, having the following features:
a′) is constituted by a metal alloy containing a first metal (1) or a first mixture of metals (1a, 1b, 1c, . . . In) in a percentage comprised between 90% and 99% by mass of the total mass and containing a second metal (2) or a second mixture of metals (2a, 2b, 2c, . . . 2n) in a percentage comprised between 1% and 10% by mass of the total mass;
b′) its thickness is equal to, or lower than, 10 cm; characterized in that the first metal (1) is an amagnetic metal, for example diamagnetic or paramagnetic or antiferromagnetic metal, and the first mixture of metals (1a, 1b, 1c, . . . In) or the first mixture of metals is amagnetic and/or exclusively comprises non-magnetic metals and in that the second metal (2) is a ferromagnetic or ferrimagnetic metal and the second mixture of metals (2a, 2b, 2c, . . . 2n) exclusively comprises ferromagnetic or ferrimagnetic metals, so that the film has ferromagnetic behavior.

12. Film (10) according to claim 11, having thickness lower than 500 microns.

13. Film (10) according to claim 11, wherein the alloy contains less than 1% by mass of:
one or more rare-earth elements, wherein the rare-earth elements are identified according to IUPAC definition, or an oxide thereof, or else
MishMetal, in its turn composed of cerium 50%, lanthanum 25% and a little percentage of neodymium and praseodymium;
non-metals, such as carbon, and/or semimetals, such as silicon.

14. Film (10) according to claim 11, wherein the mass content of the first metal (1) or the first mixture of metals (1a, 1b, 1c, . . . In), with respect to the total mass of the alloy, is comprised between 95% and 99%, and the mass content of the second metal (2) or the second mixture of metals (2a, 2b, 2c, 2n), with respect to the total mass of the alloy, is comprised between 1% and 5%, and preferably between 1% and .ο.

15. Film (10) according to claim 11, wherein the first metal (1) is selected from silver, copper, aluminum, platinum, boron and the first mixture is a mixture of two or more first metals and the second metal (2) is one from nickel, iron, cobalt, and the second mixture is from two or more second metals.

16. Film (10) according to claim 11, wherein:
the titanium content in the alloy, if present, is lower than 0.5% by mass of the total mass, and is preferably comprised in the range 0.1%-0.2%;
the boron content in the alloy, if present, is lower than 0.5% by mass of the total mass, and is preferably comprised in the range 0.1%-0.2%;
the iron content in the alloy, if present, is lower than 3% by mass of the total mass, and is preferably comprised in the range 1%-3%.

17. Film (10) according to claim 11, characterized by being coupled with other plastic materials or glasses, or borosilicate glasses or ceramics, in order to define a multilayer structure, wherein the other materials are selected to lend the desired mechanical, thermal or electrical features to the film, for example to stiffen the film, maximize the heat exchange or electrically insulate the film itself.

18. Film (10′) according to claim 17, characterized by being confined in a cavity defined by layers of different materials, under vacuum conditions, so that it can switch to the liquid state when induction heated up to reach the melting point, and can return to solid state by getting cold with no induction, in order to allow exploiting the latent heat of fusion and latent heat of solidification of the alloy the film is constituted by.

19. Film (10′) according to claim 11, characterized by being embossed to maximize the surface exposed to magnetic fields.

20. A film (10) directly obtained by the method according to claim 11.

21. (canceled)

22. (canceled)
